(19) United States
(12) Patent Application Publication
(10) Pub. No.: US 2020/0202375 A1
(43) Pub. Date: Jun. 25, 2020

(54) SYSTEM FOR PEER-TO-PEER ADVERTISING

(71) Applicants: Nathan Andrew Doyle, SR., Bakersfield, CA (US); Kevin Yebuah, Bakersfield, CA (US)

(72) Inventors: Nathan Andrew Doyle, SR., Bakersfield, CA (US); Kevin Yebuah, Bakersfield, CA (US)

(21) Appl. No.: 16/268,619

(22) Filed: Feb. 6, 2019

Related U.S. Application Data
(60) Provisional application No. 62/782,046, filed on Dec. 19, 2018.

(51) Int. Cl. G06Q 30/02

(52) U.S. Cl. CPC G06Q 30/0209; G06Q 30/0273

(57) ABSTRACT

A peer-to-peer advertising system having a database in communication with one or more computing devices via a network, the database is configured to store a plurality of tasks, each of the plurality of tasks including advertising content, each advertising content is created by a user within the community of users. Users can post advertising content which can be voted on by users within the community.

### CROSS-REFERENCE TO RELATED APPLICATIONS

This application claims priority to U.S. Provisional Application 62/782,046 entitled “SYSTEM FOR PEER-TO-PEER ADVERTISING” and filed Dec. 19, 2018, which is hereby incorporated by reference in its entirety.

### FIELD

The embodiments relate to systems for peer-to-peer advertising over a network.

### BACKGROUND

People around the world have become increasingly connected via the internet. Many users use the internet for consuming information, commerce, and staying in contact with friends and family.

The increase in the use of the internet has caused online marketing to become a necessary means for business advertising. In 2017, internet advertising revenues totaled $83 billion in the US alone. In particular, many businesses use display advertising to visually advertise their message in the form of videos, text, logos, animations, photographs, or other graphics. Many companies spend a substantial portion of their revenues to ensure their message is captured and made available to the public in hopes of increasing profits.

Often, businesses must hire marketing professionals to manage and create their advertisement campaign. This can become costly depending on the level of sophistication for each advertisement. No systems exist which utilize a community of users to aid in the creation of advertisements.

### SUMMARY OF THE INVENTION

Embodiments disclosed herein provide a peer-to-peer advertising system having a database in communication with one or more computing devices via a network. The database is configured to store a plurality of tasks, each of the plurality of tasks including advertising content. Each advertising content is created by a user within the community of users. Users can post advertising content which can be voted on by users within the community. Upon the successful completion of the task, the user is compensated at a predetermined rate.

In one aspect, a challenger creates a task to be displayed to the community of users. Contenders can select a task they are interested in executing and engage with the task for submission to the challenger.

In one aspect, the community of users vote on the contenders who executed the defined task to determine a winner. The winner may receive compensation from the challenger who is predetermined by the challenger before the task being posted.

In one aspect, the compensation amount is stored by the database as a token. A total number of stored tokens is displayed to the user such that the user can utilize the tokens as currency.

Following a voting protocol, the winning task is displayed to the community of users for a predetermined period of time. However, in some aspects of the embodiments, the challenger may select the winning contender without voting by the community of users.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a block diagram of the home screen interface, according to some embodiments;

FIG. 2 illustrates a block diagram of the task user-flow, according to some embodiments;

FIG. 3 illustrates a block diagram of the “My Tasks” user-flow, according to some embodiments;

FIG. 4 illustrates a block diagram of the “Post Task” user-flow, according to some embodiments;

FIG. 5 illustrates a block diagram of the task dispute user-flow, according to some embodiments;

FIG. 6 illustrates a block diagram of the public video user-flow, according to some embodiments;

FIG. 7 illustrates a flowchart of the dispute resolution process, according to some embodiments;

FIG. 8 illustrates a block diagram of the contest user-flow, according to some embodiments;

FIG. 9 illustrates a public peer-to-peer advertisement task graphical user interface, according to some embodiments;

FIG. 10 illustrates a graphical user interface for the peer-to-peer advertisement system, according to some embodiments;

FIG. 11 illustrates a block diagram of the network infrastructure, according to some embodiments; and

FIG. 12 illustrates a block diagram of the application system and modules, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, the term “user” can include any individual or enterprise, such as an advertising organization, in communication with the system via the network. Users may include contenders and challengers, wherein a challenger submits a task for engagement by a contender. The task can include a request for advertising material which the challenger must execute in a predetermined amount of time. The executed tasks submitted by the contenders are then voted on by the users within the community. The term “contender” can include any user who submits advertising content, receives a ranking or rating, and receives compensation from the challenger for executing a task. Users are not required to submit advertising content and act as a contender but may engage with the advertising content displayed by the system.

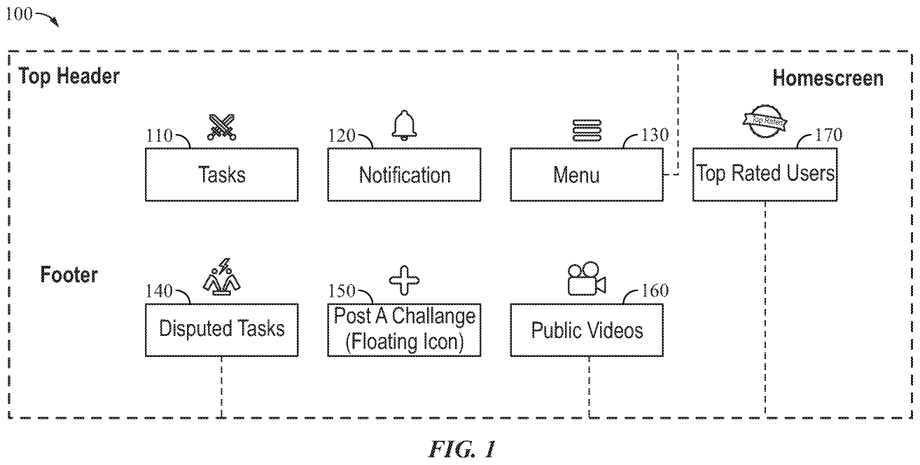

FIG. 1 illustrates the system home screen interface 100 which provides a platform for users to generate tasks which can be engaged with by the community of users. The home screen interface 100 provides a plurality of selectable icons including a task icon 110, notification icon 120, menu icon 130, disputed tasks icon 140, post challenge icon 150, public videos icon 160, and top rates user icon 170.

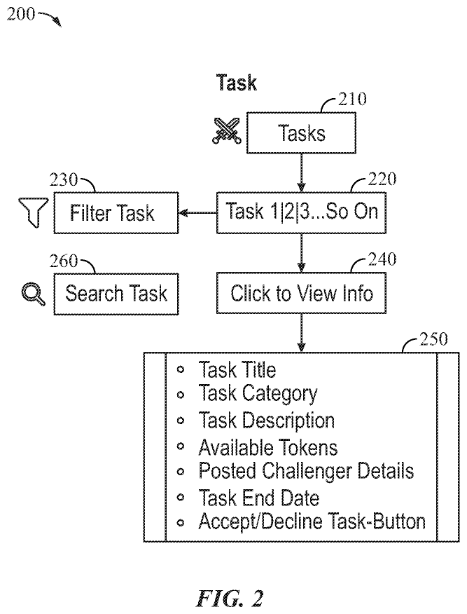

In one example, and in reference to FIG. 2, a task interface 200 can include a request for the creation of an advertisement. Each task may be provided with a title, category, description, token amount, challenger details, a start and/or end date, and an accept or decline button. Tasks 210 are posted by users of the system and displayed on the task interface 200 permitting the user to engage therewith. A task list 220 is provided, and the user may filter tasks 230 in the list. The user may select the task 240 to view information shown in box 250 by way of example. Further, a search task 260 feature is provided to allow the user to search for a specific task 210.

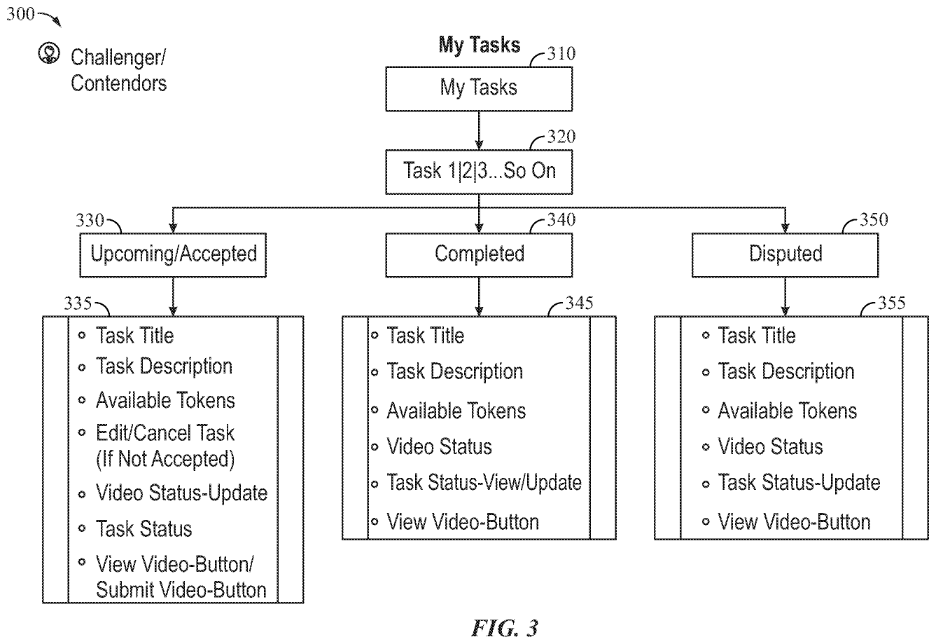

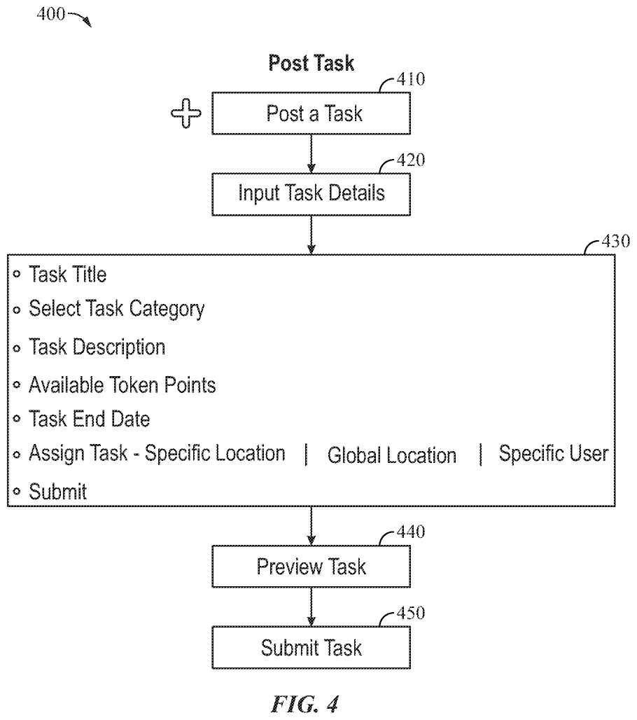

In some embodiments, a user may engage with a “My Tasks” interface 300 to view upcoming/accepted, completed, and disputed tasks as shown in FIG. 3. The user can engage with tasks they are currently performing (“My Tasks” 310) provided in a list 320. Selecting the button for upcoming/accepted tasks 330 allows the user to view upcoming tasks and various associated information thereof (as shown in box 335). Selecting the completed task 340 button allows the user to view completed tasks and associated information thereof (as shown in box 345), while selecting the disputed tasks 350 button similarly displays information gas shown in box 355) related to any disputed tasks associated with the user. The user may update a task status by declaring a winner or raising a dispute. Once the user has declared a winner, the token amount for the associated task will be transferred to the winning user's account the option to raise a dispute is selected, the associated task will be transmitted to the dispute system.

To create a task for the engagement by other users within the system, the user elects to post a task using the post task interface 400 and provide associated information thereto. The user selects to post a task at block 410 and input, task details at block 420. Task details can include a task title, task category, task description, available token points or credits, task end date, assign task feature, and submit feature as shown in block 430. The user may be provided the option to preview the task 440 during the posting process. Once the task is created, the user submits the task in block 450, making the task visible to the community of users. While users engage with the task, the system monitors the token amount in the account of the user which posted the task. Tokens are only transferred from the challengers (the user which created the task) account to the contenders (the user executing the task) account when the task is verified by the challenger.

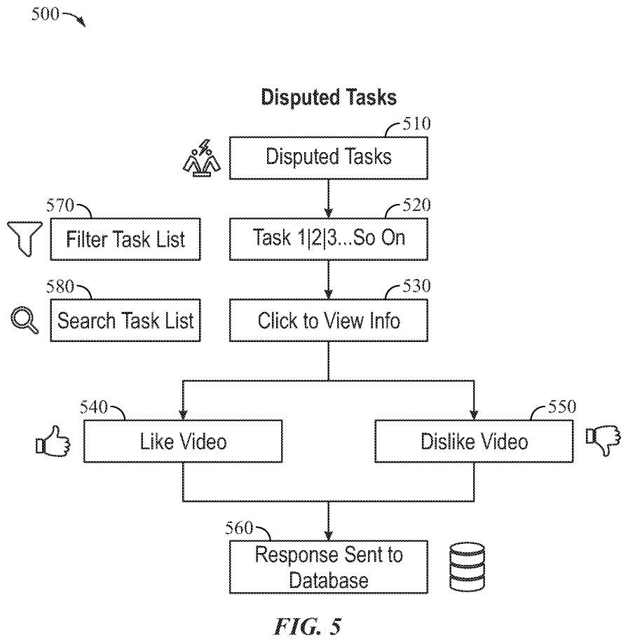

In some embodiments, tasks may be disputed by the community of users using a dispute interface 500 as shown in FIG. 5. During the dispute, users can approve (like) or deny (dislike) the task execution by a particular contender. Each approval or denial response is saved in the database, and the cumulative total for each is monitored. Once a resolution is reached for the task, the approved task will be made public such that the community of users may view the executed task. By way of example, a disputed task icon 510 may be selected which displays a list of disputed tasks 520 on the interface. The user may click to view information related to the disputed task in block 530. When viewing the information, the option to submit a response such as to like 540 or dislike 550 a task execution (such as a video) is provided. The response is then submitted to a database in block 560. The user may choose to filter disputed tasks in block 570 or search disputed tasks in block 570.

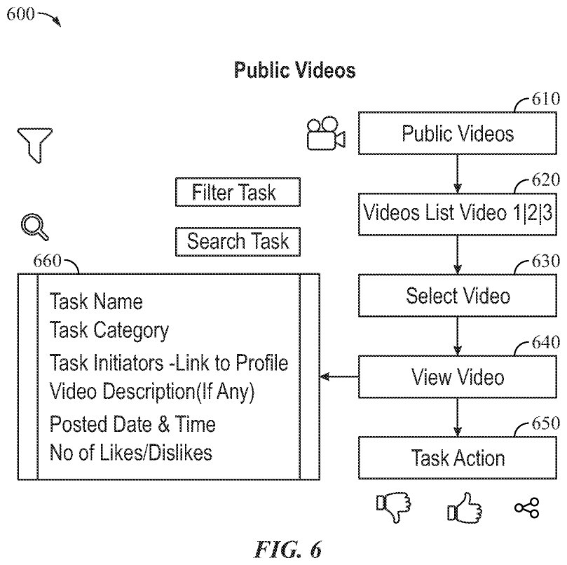

FIG. 6 illustrates the user-flow 600 when engaging with a publicly available task 610, such as a video advertisement. The user can engage with a video list 620 and select a video 630 in order to view the video 640. A task action 650 can be provided which may include a response such as a like or dislike of the video. The video displays various information as shown in block 660. The user may view associated information related to the task such as the title, category, task initiator, description, postdate, and the total amount of likes and dislike of the view.

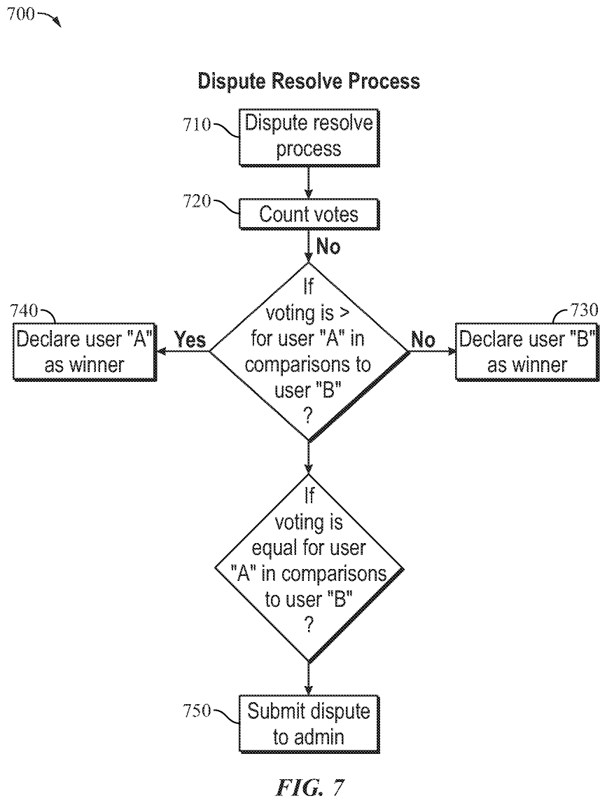

FIG. 7 illustrates a flowchart 700 of the dispute resolution process 710, according to an exemplary embodiment. When a task is created, multiple users can execute the task and submit the executed task for a vote by the community of users. Votes are counted in block 720 for each executor of the task. The executor who receives the largest number of votes becomes the winner who receives tokens or other pre-determined forms of compensation. Compensation can include both monetary and non-monetary forms of compensation. In some embodiments, voting can be timed or given a threshold such that votes are only counted for a predetermined time period, or only counted to a predetermined threshold value. Votes are counted in block 720 and compared between a first user (User A) and a second user (User B). If votes received is greater for User A (block 740 they are designated as the winner, likewise for User B (block 730). If votes are equal for Users A and B the system submits a dispute to an administrator in block 750.

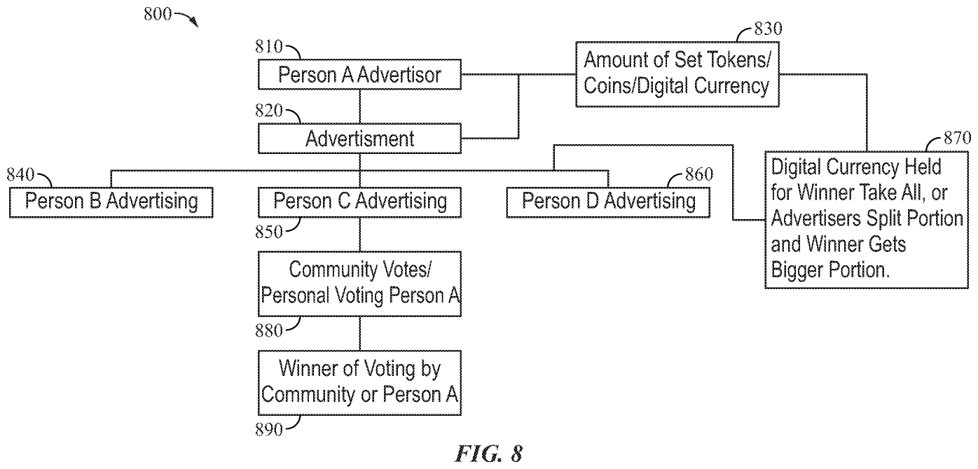

FIG. 8 illustrates a user-flow for the contest system 800. A token amount is held for the winner of the contest. In some embodiments, advertisers may take a percentage of the token amount for the contest. In one example, an advertiser 810 submits an advertisement 820 and may submit an amount of tokens or credits in block 830. Advertising is performed by various users 840, 850, 860 and submitted for voting by users in the community. In block 870, tokens or credits are held such that the advertisers can receive the tokens or credits following a community vote in block 880 and determination of a winner from the votes in block 890.

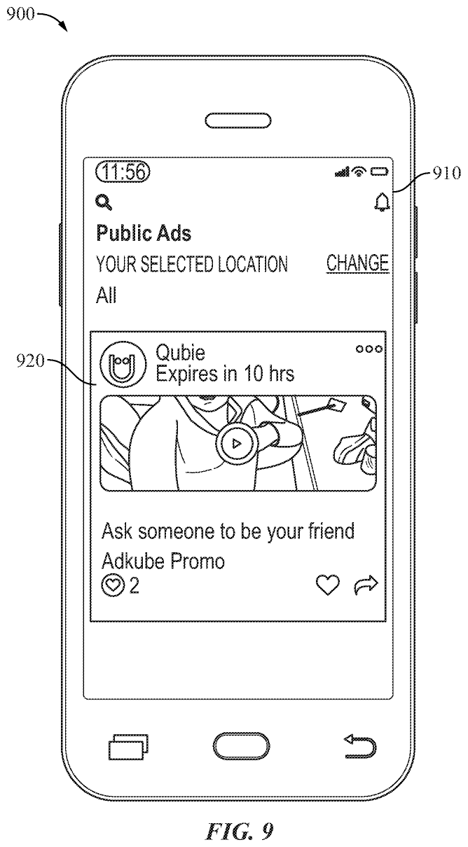

FIG. 9 illustrates an exemplary graphical user interface 900 for a public advertisement having a public advertisement interface 910 permitting the user to engage with a public advertisement 920. The public advertisement 920 can include a video or other form of media.

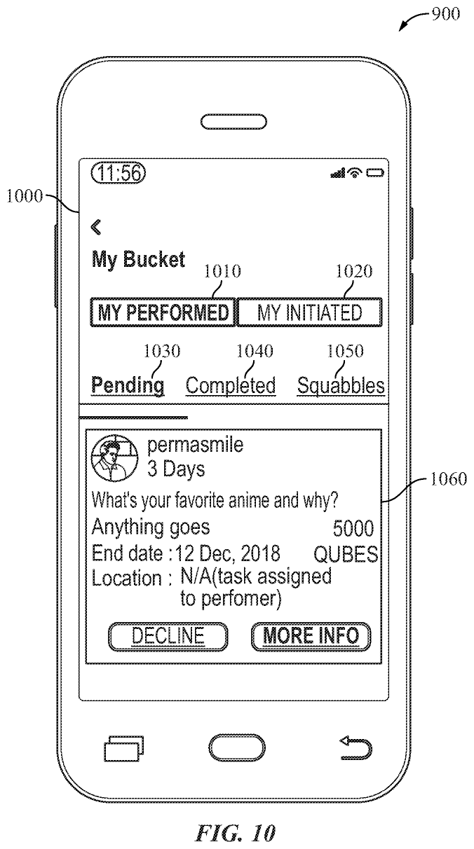

FIG. 10 illustrates the graphical user interface 900 displaying a “My Bucket” interface 1000 wherein users can select from selectable tabs including a. “My Performed” tab 1010, a “My initiated” tab 1020, a “Pending” 1030, “Completed” 1040, and “Squabbles” 1050. A pending interface 1060 illustrates details for a pending task which can include a task token value, task end date, task location, and the functionalities of declining, accepting, or receiving more information for the pending task.

FIG. 11 illustrates a block diagram of the system infrastructure including a network 1100, a plurality of computing devices 1110, and users 1120. Third-party users 1150 can include advertisers, payment processors, or other users of the system. Server 1130 sends and receives information from a database 1140 to and from the computing device 1110 via the network 1100. The database 1140 is configured to store instructions to operate the system as described hereinabove. Information can include tokens or credits assigned to a user, user credentials, user preferences, and data associated with tasks.

In some embodiments, a computing device is in wireless communication via a network. A network server sends and receives data stored to and from a database. The network may be the Internet, a cellular network, a wired network, a wireless network, a cloud computing network, or other conventional network technology recognized in the art. It should be understood that, in practice, there will be plural and likely a large number of computing devices and provider computing devices connected to the network. The network server may be a unitary device but would preferably be implemented as a server farm or a distributed computing system to handle large capacities of virtual content stored in the database and the many simultaneous connections with computing devices. Further examples of communication networks include a local area network (“LAN”), a wide area network (“WAN”), an inter-network (e.g., the Internet), and peer-to-peer networks (e.g., ad hoc peer-to-peer networks).

In some embodiments, the system is world-wide-web (www) based, and the network server is a web server delivering HTML, XML, etc., web pages to the computing devices. In other embodiments, a client-server architecture may be implemented, in which network server executes enterprise and custom software, exchanging data with custom client applications running on the computing device and the third-party user computing device.

The computing device and provider computing device may include conventional components such as one or more memory components and one or more processors. Examples of computing devices include such known mobile devices as smartphones, tablets, etc., but it should be understood that the computing device need not be a mobile device and the inventive concepts apply to other computing devices.

Processors suitable for the execution of a computer program include both general and special purpose microprocessors and any one or more processors of any digital computing device. The processor will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive). Memory devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The memory module may include a computer readable medium storing the application, which may include instructions. In an embodiment, the memory module may contain different components for retrieving, presenting, changing, and saving data and may include computer-readable media. The memory module may include a variety of memory devices, for example, Dynamic Random-Access Memory (DRAM), Static RAM (SRAM), flash memory, cache memory, and other memory devices. Additionally, for example, a memory module and processors may be distributed across several different computing devices that collectively comprise a system. The memory module is capable of storing each user-generated information to be displayed on the computing device display.

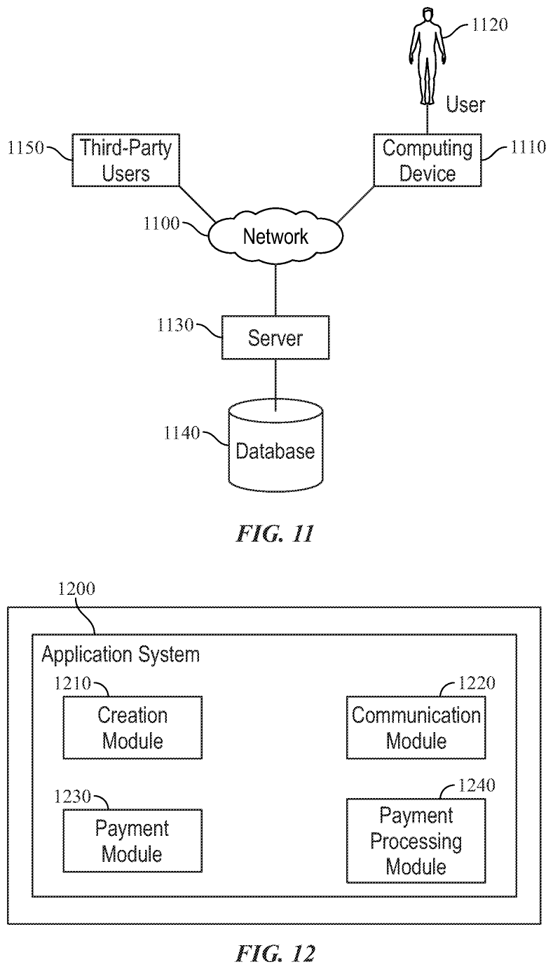

FIG. 12 illustrates a block diagram of the application system 1200 operable, via one or more processors to execute instructions stored in the database. The application system 1200 is comprised of a plurality of modules including a creation module 1210, a communication module 1220, a rating module 1230, and a payment processing module 124. The creation module 1210 permits the user to create content, including advertisements using the computing device having the application system 1200 operating thereon. The creation module 1210 may access the computing device camera, or an external camera, to capture video, still image, and/or audio data and submit the data to the database. The communication module 1220 provides a communication interface wherein the users may input text or audio communications to users in the network using input/output devices in communication with the computing device. The rating module 1230 aggregates votes from the users in the community in relation to a task. The rating module 1230 determines a winner of a dispute and may notify the winner and losers following a predetermined period of time. The rating module may also rank contender (users) in a hierarchical list. The payment processing module 1240 processes payments of traditional money, tokens, or credits between users of the system. The payment processing system 1240 may be in communication with a financial institution.

In some embodiments, a token total is stored in the database and is accessible by the associated user. The tokens may be used as a currency within the application system, such that users may purchase advertising services from other users in the community using their tokens. An external payment processing system can be integrated with the application to export funds to the user.

In some embodiments, a user who is currently executing a task must confirm completion of the in-progress task before they can begin a new task.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for peer-to-peer advertising comprising:
a database in communication with one or more computing devices via a network, the database is configured to store a plurality of tasks, each of the plurality of tasks including advertising content, each advertising content is created by a user within the community of users and associated with a compensation value.

2. The system of claim 1, wherein a challenger creates a task to be displayed to the community of users, wherein a contender executes the task.

3. The system of claim 2, wherein the community of users vote on the contenders executed the task to determine a winner.

4. The system of claim 3, wherein the winner receives the compensation value from the challenger.

5. The system of claim 4, wherein the winning task is displayed to the community of users for a predetermined period of time.

6. The system of claim 5, wherein the challenger selects the winning contender without voting by the community of users.

7. A system for peer-to-peer advertising comprising:
a database in communication with one or more computing devices via a network, the database is configured to store a plurality of tasks created by a challenger, a compensation value is associated, via the challenger, with each of the plurality of tasks, each of the plurality of tasks including advertising content created by a contender via a camera associated with at least one computing devices, the advertising content is submitted, via the contender, to a dispute interface permitting users to vote on the advertising content to determine a winner, the winner is credited with the compensation value.

8. The system of claim 7, wherein a user performs the steps of:
creating, via a challenger, the task to create advertising content;
assigning a compensation value to the task;
performing, via a contender, the task;
accepting or denying the task; and
providing the accepted task to the community of users.

9. The system of claim 8, wherein a challenger creates a task to be displayed to the community of users, wherein a contender executed the task.

10. The system of claim 9, wherein the community of users vote on the contenders executed task to determine a winner.

11. The system of claim 10, wherein the winner receives a compensation from the challenger, wherein the compensation amount is predetermined by the challenger.

12. The system of claim 11, wherein the compensation amount is stored by the database as a token, wherein a total number of stored tokens is displayed to the user.

13. The system of claim 12, wherein the stored tokens are used as a currency within the system.

14. The system of claim 13, wherein the winning task is displayed to the community of users for a predetermined period of time.

15. The system of claim 14, wherein the challenger selects the winning contender without voting by the community of users.

16. A system for peer-to-peer advertising comprising:
a database in communication with one or more computing devices via a network, the database is configured to store a instructions for an application system comprised of a plurality of modules configured to execute the instructions, the database further configured to store a plurality of tasks created by a challenger and a compensation value is associated, via the challenger, with each of the plurality of tasks, each of the plurality of tasks including advertising content created by a contender via a camera associated with the one or more computing devices, the advertising content is submitted, via the contender, to a dispute interface permitting users to vote on the advertising content to determine a winner, the winner is credited with the compensation value.

17. The system of claim 16, wherein the plurality of modules is comprised of:
a creation module to permit the contender and the challenger to create content and transmit the content to a user interface;
a communication module, to permit communication between the contender and the challenger;
a rating module to aggregate a plurality of votes input on the dispute interface, and to determine the winner; and
a payment processing module configured to transmit the compensation value from the challenger to the contender.

18. The system of claim 17, wherein the votes are aggregated by counting a like total and a dislike total for the executed task.

19. The system of claim 18, wherein each task is comprised of a task title, the compensation value, a task location, and a task description.

20. The system of claim 17, wherein the contenders are ranked into a hierarchical list.
